(19) United States
(12) Patent Application Publication
(10) Pub. No.: US 2013/0016510 A1
(43) Pub. Date: Jan. 17, 2013

(54) MODULAR LED ILLUMINATION APPARATUS

(71) Applicants: Brian C. Sanders, Salem, NH (US); Frederick A. Wright, Manchester, NH (US)

(72) Inventors: Brian C. Sanders, Salem, NH (US); Frederick A. Wright, Manchester, NH (US)

(21) Appl. No.: 13/543,798

(22) Filed: Jul. 7, 2012

Related U.S. Application Data
(60) Provisional application No. 61/572,124, filed on Jul. 12, 2011.

(51) Int. Cl. F21V 5/04; F21V 29/00

(52) U.S. Cl. 362/235

(57) ABSTRACT

An illumination module that can be retrofitted to a common cobra head and shoebox style street and parking lot pole mounted light housings. This module can reduce the energy requirements by as much as 85%. The module also eliminates the typical required heat sinks. A self contained insect repulsion module that is “insect-tuned” is provided. This repulsion module is set at a frequency that discourages any infestation. A back-up photocell module turns the light “OFF” when the ambient light is above a certain threshold if the primary photocell fails. A lens housing structure substantially reduces extraneous upward and side illumination. The module can be retrofitted using only two simple steps, taking only about ten minutes using only common hand tools.

This application claims benefit of U.S. Provisional Application Ser. No. 61/572,124 filed on Jul. 12, 2011, pursuant to 35 USC §119(e).

### FIELD OF THE INVENTION

This present invention relates to the field of Light Emitting Diodes (LED) and, in particular, to an illumination module which houses LEDs on printed circuit boards (PCBs) in a lightweight, plastic housing that can be retrofitted to common cobra head and shoebox style street and parking lot pole mounted light housings.

### BACKGROUND OF THE INVENTION

From their initial introduction into the global market, cobra head or similar light fixtures have become the standards for street, highway, and parking lot lighting. Manufactured by General Electric, Sylvania, American Electric, Cooper Industries, Simkar, and others for more than fifty years, the popularity of this style of street lighting fixtures have resulted in many millions being used globally. A typical schematic of the major components of such lighting fixtures is shown in FIG. 1. The illumination outputs of these original cast aluminum fixtures include 100, 150, 175, 200, 250, and 400 watt, Mercury Vapor, High-Pressure Sodium, and Metal Halide lamps. The electric power for these units is supplied by the local AC power grid.

Internally, each fixture requires a photocell (light sensor), ballast circuit to provide proper starting and operating power to the lamp, a “wrap around” to assist in reflecting light from the back side of the lamp to the outside of the fixture aperture, and one of several types of molded acrylic or tempered glass lens. The most common type of cobra head lens in service is a prismatic acrylic, elongated, half-globe lens designed to provide a substantial air envelope around the prior art lamp and spread light in all directions, permitting a significant amount of undesirable sideward and upward illumination into the night sky. Cobra head and shoebox pole lights may also use a flat or shallow bowl shaped non-prismatic tempered glass lens that helps reduce night sky illumination, as defined by the International Dark-Sky Association (IDA). This design increases the concentration of heat produced by the lamps. Misdirected light loss and excessive internal heating directly contribute to reduction in energy efficiency, reduction in illumination quality and short-life. Constant replacement of prior art lamps in pole mounted fixtures is extremely costly.

Prior art LED street, highway, and parking lot lighting fixtures have used high power 1,000 mW (milliwatt), 500 mW, 250 mW, and 180 mW LED components. However, this has required the use of massive finned aluminum heat sinks to remove lost energy generated in the form of heat rather than light to prevent early failure of the unit.

Prior art cobra head or similar street fixtures were originally implemented with insect guard partitions designed to prevent or reduce insect and vermin infestation. Through many years of operation, these internal components have been proven to be ultimately ineffective in prevention of large population hives including wasps, bees and yellow jackets.

Prior art LED Fixtures require continuous airflow around their massive heat sinks Prior art LED Fixture manufacturers have indicated that the results from excessive overheating has lead to various system malfunctions. These prior art LED fixtures are vulnerable to excessive heat conditions when air vents and chambers are blocked by insect infestation.

Prior art cobra head or similar street fixtures can experience a continuous “ON” condition due to a failed photocell detector. This condition wastes energy and decreases the life of the prior art lamps.

Finally, these lights are typically expensive to replace since as noted above, the life span of this type of illumination reduces life expectancy of the lamp due to excessive internal heating.

There is not found in the prior art, a LED illumination apparatus that can be easily retrofitted into all present varieties of cobra style and shoebox style street and parking lot lighting fixtures; that can reduce the energy requirements by as much as 85%; that can eliminate the typical required heat sinks; that has a self contained insect repulsion module that is “insect-tuned” to provide a frequency that discourages any infestation; that has a back-up photocell module that turns the light “OFF” when the ambient light is above a certain threshold if the primary photocell fails; that provides a lens housing structure that substantially reduces upward and side illumination; that can substantially increase the life expectancy of the lighting apparatus and that can be retrofitted using only two simple steps, taking only about ten minutes using only common hand tools.

### SUMMARY OF THE INVENTION

The present invention replaces the original prior art mirror-finished reflector, prismatic lens, high wattage lamp, lamp socket, and power ballast components. If equipped, the power terminal block, light sensor, and tempered glass lens are retained in the housing for use with the LED Illumination Retrofit Module.

It is an aspect of the invention to provide a modular LED illumination apparatus that eliminates a continuous “ON” condition by providing a back-up photocell module.

It is another aspect of the invention to provide a modular LED illumination apparatus that has a self contained insect repulsion module.

It is still another aspect of the invention to provide a modular LED illumination apparatus that reduces energy requirements by as much as 85% when compared to present art lamp based, pole mounted street and parking lot light fixtures.

Another aspect of the invention is to provide a modular LED illumination apparatus that can be retrofitted to every current variation of cobra head and shoebox style street and parking lot device in use.

Still another aspect of the invention is to provide a modular LED illumination apparatus that utilizes a lens configuration that substantially reduces upward and sideways-unwanted light output.

Another aspect of the invention is to provide a modular LED illumination apparatus that increases the lifespan of the unit to as much as 50,000 hours without the need for replacement.

Another aspect of the invention is to provide a modular LED illumination apparatus that can be installed in approximately ten minutes using only readily available standard tools.

It is still another aspect of the invention to provide a modular LED illumination apparatus that has a self-contained temperature sensor module that will turn the unit “ON” if the ambient temperature falls below a predetermined temperature that could be detrimental to the proper operation of the unit.

Another aspect of the invention is to provide a modular LED illumination apparatus that retains and reuses the existing prior art fixture housing reducing both cost and waste.

Finally, it is an aspect of the invention to provide a modular LED illumination module that uses only low power, high brightness LEDs that eliminate the need of heat sinks and that can run on AC or low voltage DC to maintain efficient low wattage operation while providing proper illumination.

### BRIEF DESCRIPTION OF THE DRAWINGS

FIG. 1 is a schematic diagram of the typical prior art electrical components.

FIG. 2 is an exploded isometric view of the modular LED illumination apparatus and the mating surfaces of common shoebox and cobra head flat lens designs in accordance with the invention.

FIG. 3 is a cross section of the modular LED illumination apparatus shown in FIG. 2.

FIG. 4 is an exploded isometric view of the illumination platform and the printed circuit boards with attached power wires.

FIG. 5 is a solder side view of an unpopulated printed circuit board.

FIG. 6 is a side view of a printed circuit board with LED, resistor, and power wire details.

FIG. 7 is an exploded isometric view of the invention's venting provisions that eliminates the need for heat sinks.

FIG. 8 is a detailed isometric exploded view of the internal screw and lug wiring and power supply mounting.

FIG. 9 is a schematic diagram of the invention's basic external wiring connected to the existing prior art components.

FIG. 10 is a schematic diagram of the invention with optional adjunct modules connected to existing prior art components.

### DETAILED DESCRIPTION OF THE INVENTION

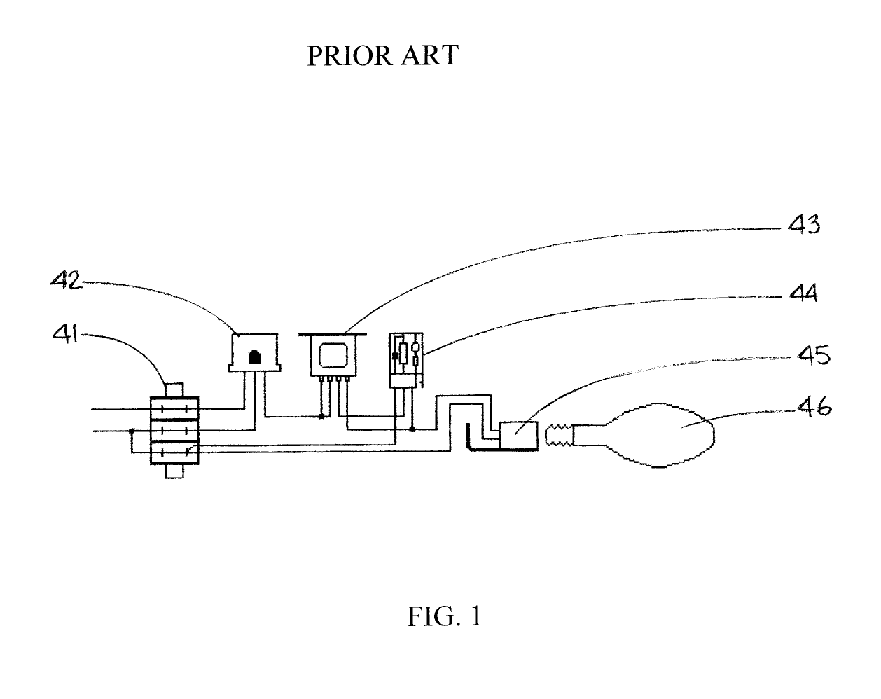

The invention is an LED Illumination Retrofit Module 2 that is a lightweight retrofit replacement for the original illumination components used in cobra head or similar street and highway lighting fixtures. As noted above, Ballast Transformer 43, the Ballast Circuit 44, the integrated Lamp Socket/Reflector Assembly 45, and Lamp 46 are removed as shown in FIG. 1. The Terminal Block 41 and Light Sensor 42, if equipped, should not be removed.

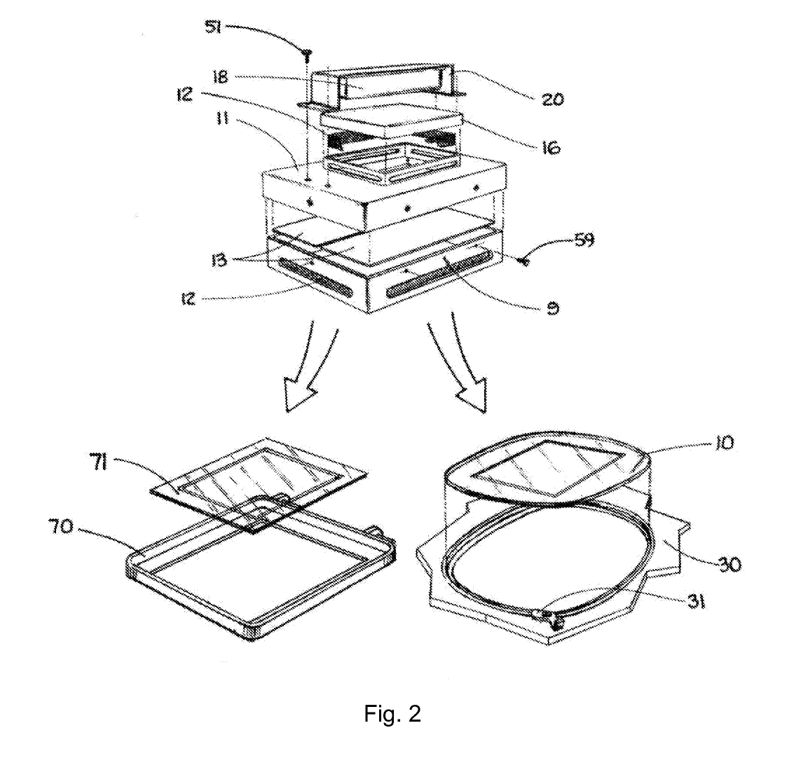

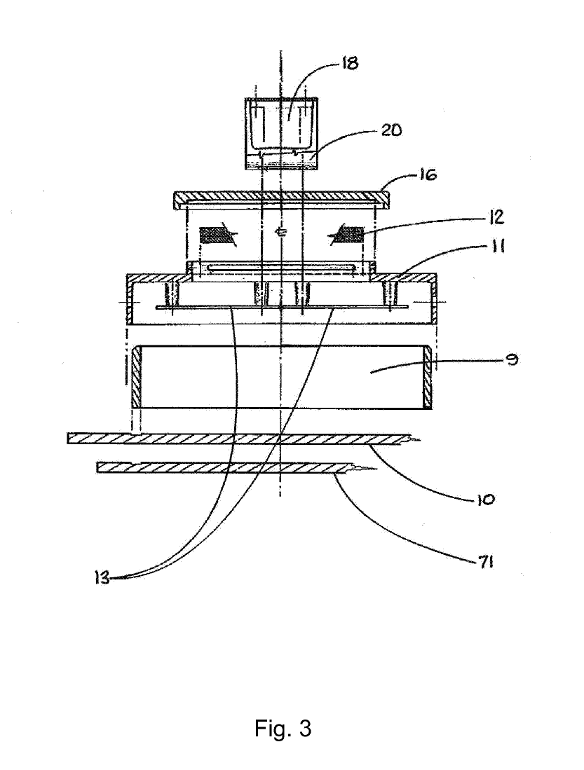

Referring to FIGS. 2 and 3, the Mounting Plate 10 provides multiple functions. Plate 10 is specifically shaped to mechanically mate with the lens groove in the drop-down, lower half of Cobra Head Housing 30. The existing lens Locking Arm 31 traps the Plate 10 to secure the Module in the housing. Plate 10 also provides the structural base to support the other parts of the invention Module 2 and Plate 10 is a clear lens through which the light is projected. Plate 71 is a typical tempered glass flat lens normally mounted in the lower half of a typical Shoe Box Housing 70 and provides the same functionality of Plate 10.

Molded Plate Ring 9 is permanently mounted to Mounting Plate 10 in a matching groove by ultrasonic welding. Ring 9 adds rigidity to Plate 10 and provides part of the interior chamber that houses PCBs 13. Ring 9 is secured to Plate 71 by a high strength, UV protected adhesive. Ring 9 has threaded holes 23 in six places that mate with through holes 24. On the Illumination Platform 11 and ½ inch wide vents on four sides to aid thermal cooling of the PCB assemblies 13.

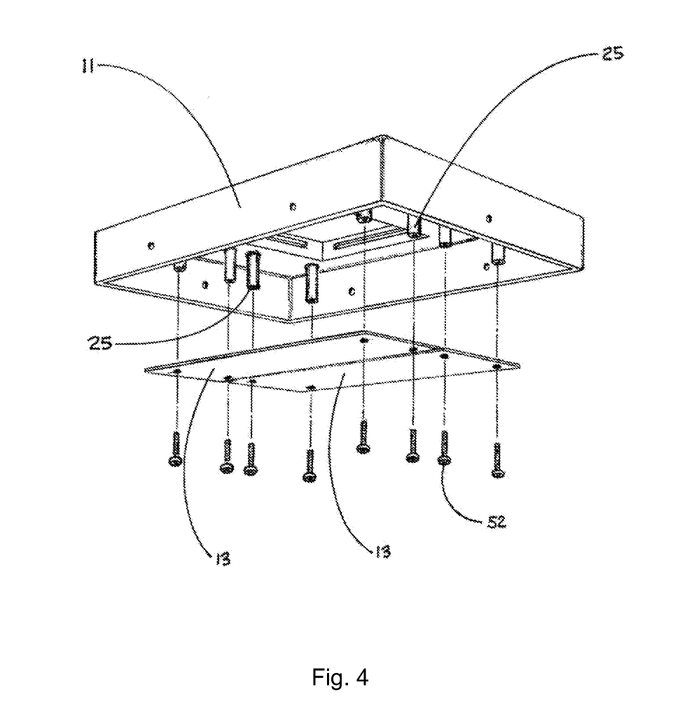

The Illumination Platform 11 fits tightly over the Molded Plate Ring 9 and is positively secured by six screws 59 to Ring 9. FIG. 4 shows in detail the molded mounting posts 25 to which PCBs 13 are secured using Screws 52.

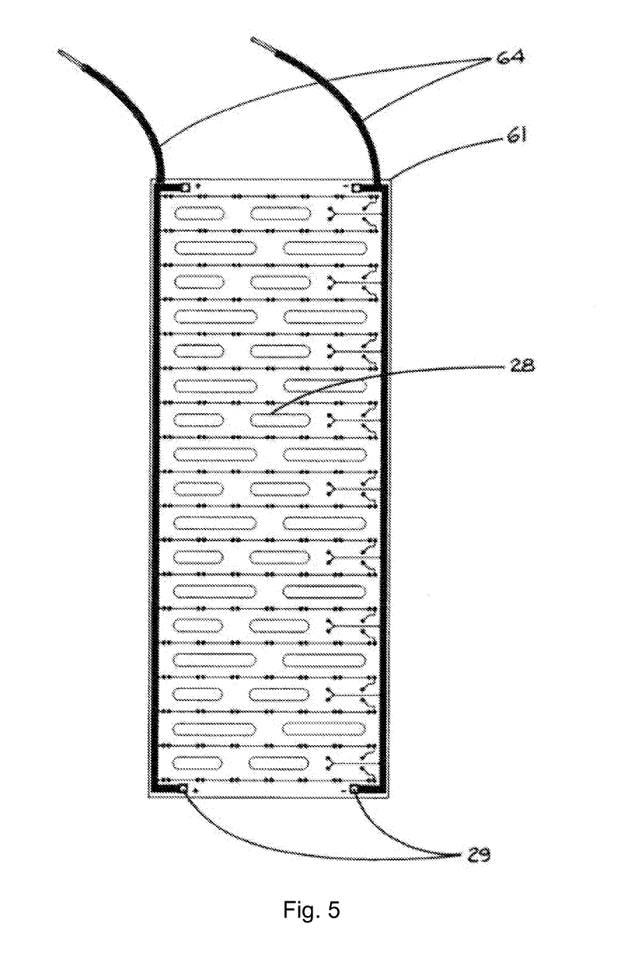

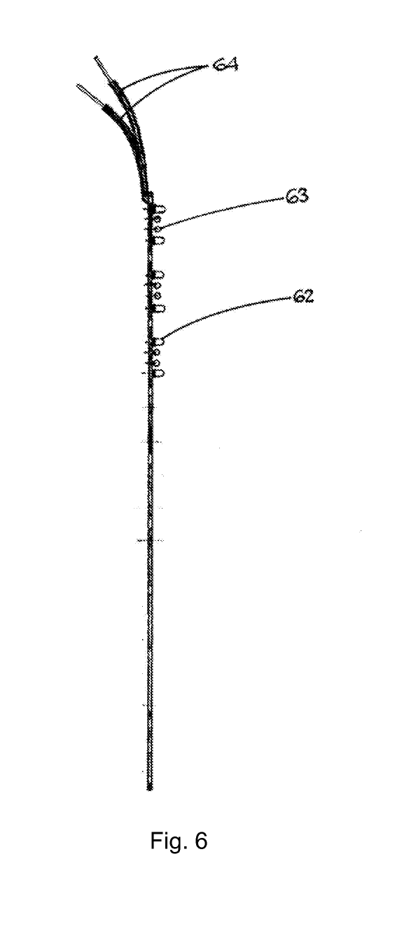

FIGS. 5 and 6 provide views of assembly 13 with Printed Circuit Board 61 showing the spacing and orientation of LEDs 62, Resistors 63, ventilation slots 28, and the positive and negative power bus mounting holes 29. Printed Circuit Boards (PCBs) 61 are the mounting platforms for the LEDs 62. LEDs 62 are arranged evenly on PCB 61 with ½ inch spacing from LED 62 center to LED 62 center. LED's 62 are arranged in eighteen parallel rows of seven series wired LEDs 62 for a total of 126 LEDs 62 per PCB 13. Each row of seven LEDs 62 is in series with a discrete, current control 110 ohm, ¼ watt, 1% resistor 63. PCBs 61 are ventilated with parallel 3/16-inch wide slots 28. Slots 28 are located between each row of LEDs 62, are arranged to maintain PCB 61 integrity, and are used to facilitate the free movement of air through the assembly.

The LED Illumination Retrofit Module invention 2 can be expanded to contain from one to four board assemblies 13. The number of boards would be determined by application parameters including the height of the pole, wattage of the original lamp, and interior size of the fixture housing.

The LEDs 62 are low power, high output, round, 5 mm, T1 ¾ clear optic cool white and warm white types such as Cree's C503 series or Kingbright's WP7113V series LEDs 62. These LEDs 62 concentrate the light output in narrow 15 and 20-degree cones respectively and produce very little heat, using a maximum of only 64 miliwatts of 24 VDC power each.

The narrow light output angles of the selected LEDs 62 allow for precise, downward control of the Module illumination pattern removing the necessity of a prism type lens. The clear, flat lens 10 used in the Module helps prevent light being released from the fixture directly into the night sky.

The low power, low heat characteristics of the LEDs 62 used in this invention allow the housing to be constructed of lightweight plastic materials. No internal metal heat sink structures are required.

Each assembly 13 requires only 9 watts of 24 VDC power. This allows for the use of a compact 24 VDC integrated power supply such as the Excelsys LDB series or Mean Well LPV series 24 VDC LED drivers. The power supply 18 is externally mounted on the Module under an aluminum bracket 20.

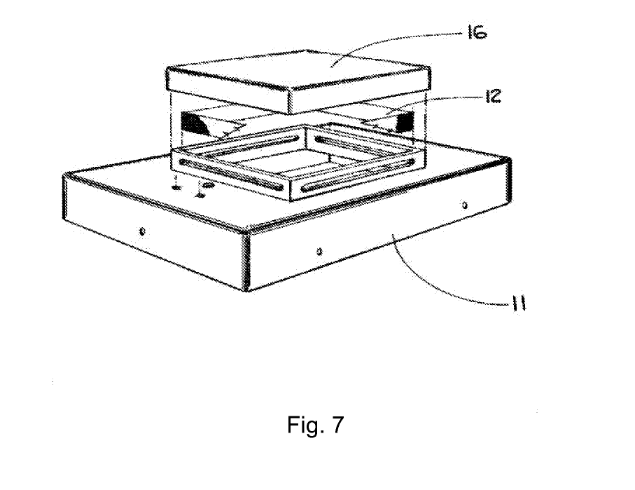

As shown in FIG. 7, an additional provision molded in the top surface of Illumination Platform 11 provides ventilation ports 26 in the four sides of an upward facing molded aperture 27. Filter Screen Panel 12 is fitted within the aperture. Ventilation Cover 16 is permanently mounted onto the top of Platform 11 completing the enclosure of the Module's interior compartment. The invention design provides four vent features 26 with a combined venting area of 2.57 square inches. These vents 26, in conjunction with the vents in Mounting Ring 9, allow what heat is produced by the LEDs 62 to easily escape the Module 2. The vents 26 are protected from insect infestation by a fine mesh 12 applied during assembly.

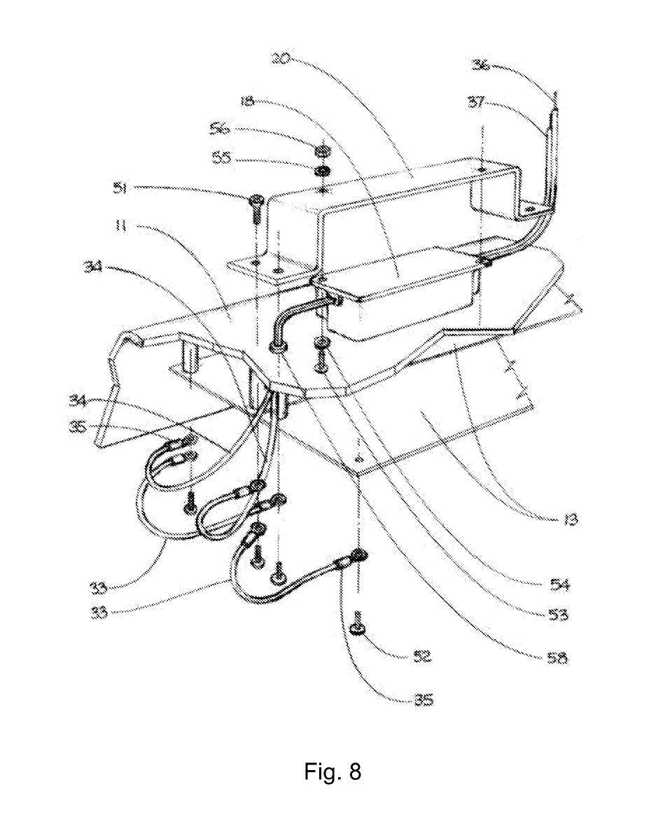

As illustrated in FIG. 8, provisions in Illumination Platform 11 permit the entry of the two output wires 34 from the 24VDC Power Supply 18 into the interior compartment. These wires 34 supply the 24 VDC to one of the assemblies 13. Jumper Wires 33 “daisy chain” the supplied power to the other assembly boards 13 in the Module 2. Electrical connection is achieved via star ring terminals on the Power Supply 18 and Jumper 33 wires. The terminals are secured to the boards using the mounting screws 52. 24 VDC can also be supplied to assemblies 13 via wire leads soldered directly to the PCB 61. Wire connections are made using common connection devices and are free of the mounting screws 52.

24VDC Power Supply 18 is mechanically fastened by two Machine Screws 53, Flat Washers 54, Lock Washers 55, and Hex Nuts 56 to formed aluminum Mounting Bracket 20. After the two output wires 34 from the Power Supply 18 are fed through the feed-through grommet 58 in the Platform 11, the Bracket 20 is fastened to Illumination Platform 11 using four Screws 51. Aluminum bracket 20 acts as both a heat sink for the 24 VDC power supply and a handle for the technician to hold the Module 2 during installation.

Again, referencing FIG. 1, the original prior art components located in the upper portion of a cobra head or similar light fixture is shown. The Ballast Transformer 43, the Ballast Circuit 44, the integrated Lamp Socket/Reflector Assembly 45, and Lamp 46 are removed. The Terminal Block 41 and Light Sensor 42 should not be removed.

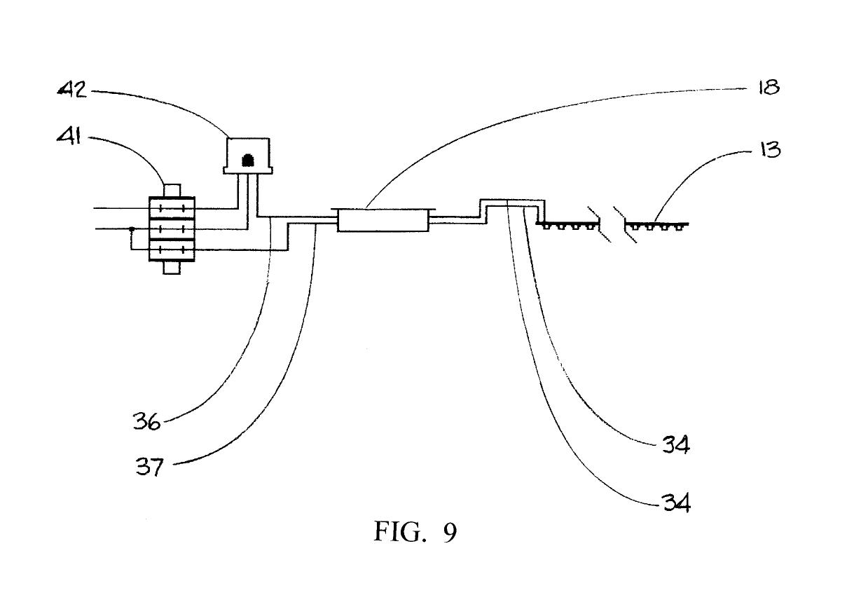

FIG. 9 is a diagram of the simplest wiring required for a basic LED Illumination Module model. 24 VDC Power Supply 18 input Line wire 36 is connected to the output wire from the prior art Light Sensor 42. Power Supply 18 Neutral wire 37 is connected to the appropriate terminal on the Terminal Block 41. The wires 34 between Power Supply 18 and PCB 13 are internal to the Module and factory connected.

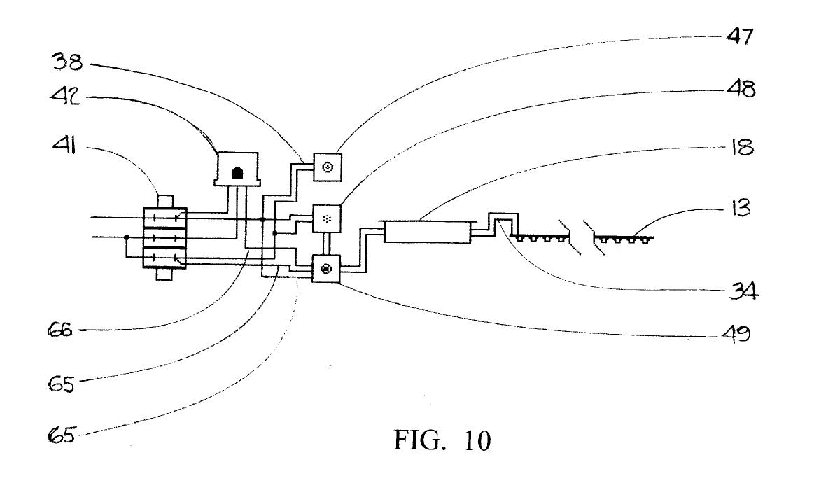

FIG. 10 is a diagram of the wiring required for the optional adjunct modules. The invention addresses three adverse conditions: insect infestation, continuously “ON”, and severe cold temperatures.

Adjunct Insect Infestation Control Module 47 is located on the pole/sidewalk end of the power supply Mounting Bracket 20 using a mounting provision. As this module must be powered continuously, it must remain independent of the Light Sensor 42 and Adjunct Photo Sensor Assembly 49. To achieve this, Module 47 has two power wires 38 connected directly to the Power Terminal Block 41. Insect Infestation Control Module 47 will help prevent the construction of bee, hornet, and wasp nests inside the cobra head housing. This adjunct module contains a circuit similar to that designed by Maynard Graham and described on the Internet website circuitdiagram.net and others and similar to the circuit used in the Sunbeam Model SB 101 Electronic Pest Repeller.

Adjunct Photo Sensor Module 49 is located on the pole/sidewalk side of the Molded Plate Latch Ring using a mounting provision. Module 49 has two wires 65 connected directly to the Power Terminal Block 41 and one wire 66 connected to the output wire from the Light Sensor 42. The output wires will be factory connected to the input wires to the 24VDC Power Supply 18. Photo Sensor Module 49 helps prevent a continuous “ON” condition caused by a failed, original light sensor in the cobra style light. This adjunct module turns “OFF” the LEDs as the ambient light increases. It also turns “ON” the LEDs at dusk. The module circuit is similar to the “Light Activated Switch Circuit” as described on the Internet website www.circuitstoday.com and others and similar to the circuit used in the Sylvania Model 72032 LED Sensor Power Failure Night Light.

Adjunct Low Temperature Safety Module 48 is located on the pole/sidewalk side of the Molded Plate Latch Ring using a mounting provision and can be factory wired to provisions on the Adjunct Photo Sensor Assembly 49. Low Temperature Safety Module 48 helps prevent damage to the LEDs and 24 VDC power supply should the daytime ambient temperature inside the cobra head-housing drop below the specifications dictated by their respective manufacturers. The module circuit is similar to that used in the Honeywell Model TS300 Dual Temperature Sensor when used in conjunction with the Honeywell Model T280R Remote Temperature Probe. Should the daytime temperature drop below a factory set point the module will turn the LEDs “ON”. The minimal heat produced by the LEDs and power supply keep these components warm until the ambient temperature rises above the sensor activation threshold.

Although the present invention has been described with reference to certain preferred embodiments thereof, other versions are readily apparent to those of ordinary skill in the art of the preferred embodiments contained herein.

What is claimed is:

1. An illumination module for a light fixture comprising:
a housing having a mounting plate;
a printed circuit board attached within said housing with said printed circuit board having an array of ventilation slots;
an LED array, also electrically connected to said printed circuit board, with said LED array interspersed between the array of ventilation slots in said printed circuit board; wherein each LED in said LED array is a low power, high output type that do not require the use of a heat sink structure and wherein the light output of each LED in said LED array produces light in narrow light output cones that eliminates the need for a prism lens;
a clear, flat lens which is a part of said mounting plate, positioned beneath said LED array, wherein said lens reduces unwanted upward and sideward illumination.

2. The illumination module of claim 1 further comprising:
a plurality of ventilation ports in the top portion of said housing and a plurality of vents in said mounting plate, wherein said ports and said vents provide sufficient ventilation to remove the heat produced by said LED array to be removed from said housing.

3. The illumination module of claim 2 further comprising:
a fine filter mesh associated with each of said ventilation ports and said vents to prevent insects from entering said housing.

4. The illumination module of claim 1 further comprising an insect infestation module attached to said housing, wherein said insect infestation module helps prevent bee, hornet and wasps from making a nest in the light fixture.

5. The illumination module of claim 1 further comprising:
a photo sensor module which is designed to prevent a continuous “on” condition when ambient light increases beyond the point wherein said illumination module does not need to be illuminated.

6. The illumination module of claim 1 further comprising:
a low temperature module wherein said LED array is turned “on” when the ambient temperature drops below a predetermined set point during the daytime such that the minimal heat produced by said LED array will warm the components until the ambient temperature rises above the predetermined set point.
